(19) United States
(12) Patent Application Publication
(10) Pub. No.: US 2016/0136884 A1
(43) Pub. Date: May 19, 2016

(54) Articles Produced by Three-Dimensional Printing with Cycloolefin Copolymers

(71) Applicant: Topas Advanced Polymers Inc., Florence, KY (US)

(72) Inventor: Timothy M. Kneale, Florence, KY (US)

(21) Appl. No.: 15/007,260

(22) Filed: Jan. 27, 2016

(51) Int. Cl. B29C 67/00; C09D 123/06; C09D 123/20; C09D 123/12; C09D 145/00; C09D 155/02

(52) U.S. Cl. CPC B29C 67/0051; C09D 145/00; C09D 155/02; C09D 123/20; C09D 123/12; C09D 123/06; B29K 2023/38

(57) ABSTRACT

A method of making a three-dimensional article includes providing a polymer blend which includes a cycloolefin copolymer and another thermoplastic resin; and printing the polymer blend into the three-dimensional article. The articles exhibits superior performance in connection with at least one of the following properties: dimensional stability; optical transmission; gloss; or barrier properties as compared with a like article made by a like process made from the thermoplastic resin in the blend only. Articles may also be formed with cycloolefin copolymer elastomer which is optionally blended with another thermoplastic.

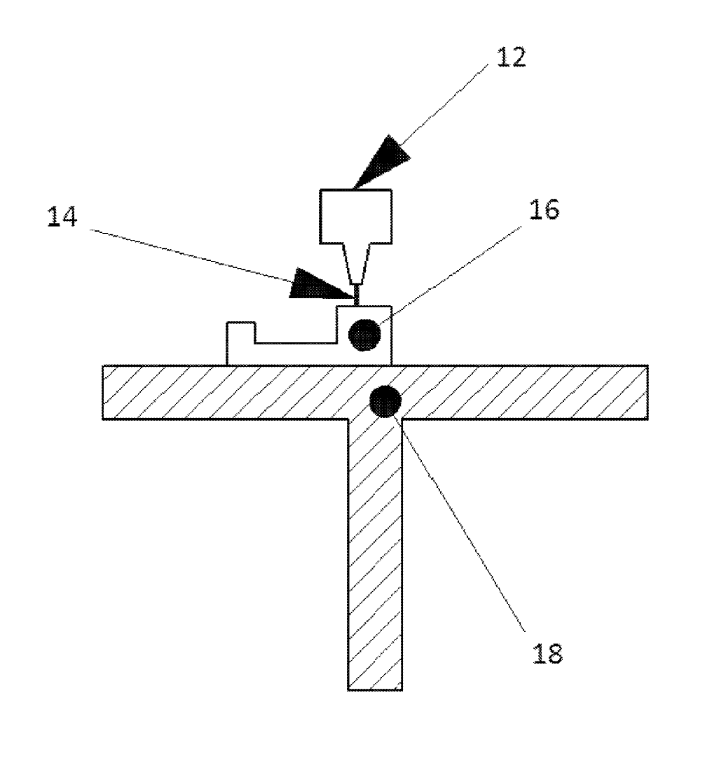

### TECHNICAL FIELD

The present invention relates to three-dimensional printing with a blend of cycloolefin copolymer and another thermoplastic resin or with cycloolefin copolymer elastomer. Sometimes these resins are referred to as cyclic olefin copolymers or cyclo-olefin copolymers.

### BACKGROUND

Thermoplastics are widely used in three-dimensional printing, particularly in connection with fused deposition modeling (FDM)(sometimes referred to as fused filament fabrication (FFF)), or selective heat sintering (SHS) or selective laser sintering (SLS).

Variants on widely used techniques and materials are seen in United States Patent Application Publication No. US 2014/0162033 which discloses a fabrication process and apparatus for producing three-dimensional objects by depositing a first polymer layer, printing a first ink layer on to the first polymer layer, depositing a second polymer layer on to the first ink layer, and printing a second ink layer on to the second polymer layer. The deposition and printing steps may be repeated until a three-dimensional object is formed. The inks used to form at least one of the first and second ink layers may include dyes or pigments so that the three-dimensional object may be a colored three-dimensional object.

Various additives are used with thermoplastics to enhance three-dimensional printing processing. There is seen in United States Patent Application Publication No. US 2007/0241482 a material system for three-dimensional printing comprising: a granular material including: a first particulate adhesive including a thermoplastic material; and an absorber capable of being heated upon exposure to electromagnetic energy sufficiently to bond the granular material.

So, also, there is seen in US 2011/0156301 a materials system provided to enable the formation of articles by three-dimensional printing. The material system includes (i) a substantially dry particulate material including an aqueous-insoluble thermoplastic particulate material, plaster, and a water-soluble adhesive; (ii) an aqueous fluid binder, and (iii) an infiltrant.

While various adjuvants may be employed in the art to facilitate processing or impart particular features to the article, the thermoplastics used are typically conventional materials such as nylons, acrylonitrile butadiene styrene polymers, other polyolefins and so forth which may be lacking in one or more properties such as dimensional stability, optical transparency or other characteristics, gloss and moisture barrier properties.

### SUMMARY OF INVENTION

There is provided in a first aspect of the invention a method of producing a three-dimensional article comprising providing a melt-blend of a cycloolefin copolymer with another thermoplastic resin and producing the article by three-dimensionally printing the polymer blend into the three-dimensional article. The three-dimensional printing methodology is optionally selected from FDM, SHS or SLS. A preferred class of polymer blends utilized in connection with the invention includes cycloolefin copolymer melt-blended with a partially crystalline olefin polymer such as polypropylene, polyethylene or partially crystalline polymers of linear alkenes such as polyoctenes.

While the materials may be used in a wide variety of proportions in the polymer blend, weight ratio of cycloolefin copolymer:other thermoplastic of from 2:98 to 98:2 are typical. In some cases, a weight ratio of cycloolefin copolymer:other thermoplastic from 2:98 to 20:80 are preferred when certain properties such as dimensional stability or gloss of the thermoplastic in the blend are targeted for improvement.

In another aspect of the invention, there are provided three-dimensional articles produced by three-dimensionally printing polymer blends of cycloolefins and another thermoplastic. The three dimensional article of the invention exhibit improvement in at least one of the following properties as compared with the same article produced by the same method with the thermoplastic resin only: dimensional stability; optional transmission; gloss; or barrier properties.

There is provided in yet another aspect of the invention a method of producing a three-dimensional article comprising providing a thermoplastic composition comprising a cycloolefin elastomer copolymer, optionally blended with another thermoplastic resin and producing the article by three-dimensionally printing the thermoplastic composition into the three-dimensional article. The three-dimensional printing methodology is also suitably selected from FDM, SHS or SLS.

In still yet another aspect of the invention, there are provided three-dimensional articles produced by three-dimensionally printing polymer compositions including cycloolefin copolymer elastomers and optionally another thermoplastic.

Still further aspects of the invention are appreciated from the discussion which follows.

### BRIEF DESCRIPTION OF DRAWING

The invention is described in detail below which is a schematic diagram of an FDM apparatus and process.

### DETAILED DESCRIPTION

The invention is described in detail below with reference to the drawing and examples. Such discussion is for purposes of illustration only. Modifications within the spirit and scope of the present invention, set forth in the appended claims, will be readily apparent to one of skill in the art.

The articles of the invention are suitably formed by any three-dimensioal printing process, that is, by any process of producing a three-dimensional article one layer at a time, now known or hereafter developed. Known techniques are sometimes referred to as binder jetting, directed energy deposition, material extrusion, material jetting, powder bed fusion, sheet lamination, vat photopolymerization and so forth. Preferred techniques include FDM, SHS or SLS as is noted above

The cycloolefin copolymer (COC) employed is typically a cycloolefin/acyclic olefin copolymer These polymers generally contain, based on the total weight of the cycloolefin copolymer, preferably from 0.1 to 99.9% by weight, of polymerized units which are derived from at least one polycyclic olefin of the formulae I, II, III, IV, V or VI, or a monocyclic olefin of the formula VII:

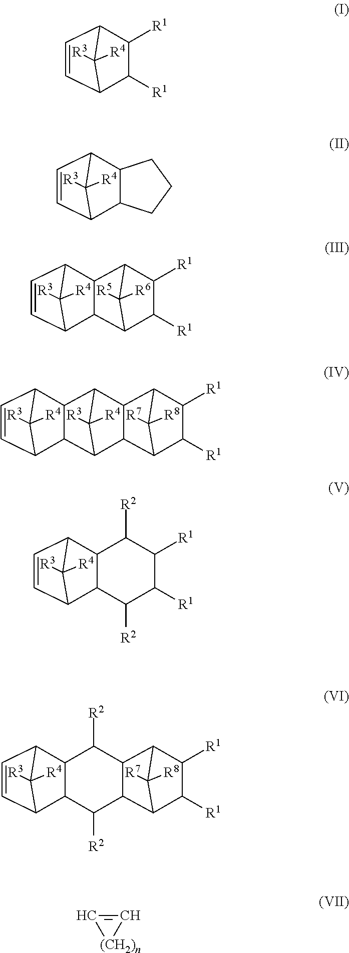

wherein R¹, R², R³, R⁴, R⁵, R⁶, R⁷ and R⁸ are the same or different and are H, a C₆-C₂₀ -aryl or C₁₋C₂₀ -alkyl radical or a halogen atom, and n is a number from 2 to 10.

Specific cycloolefin monomers are disclosed in U.S. Pat. No. 5,494,969 to Abe et al. Cols. 9-27, for example the following monomers:

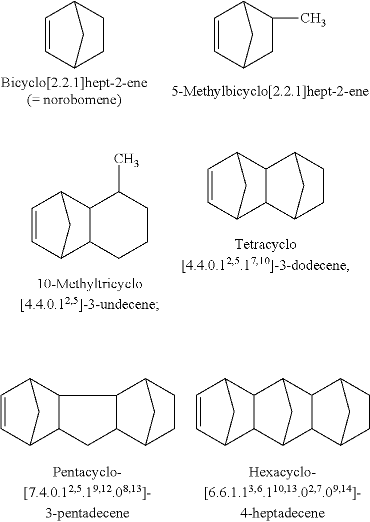

and so forth. The disclosure of U.S. Pat. No. 5,494,969 to Abe et al. Cols. 9-27 is incorporated herein by reference.

The cycloolefin units may also include derivatives of the cyclic olefins such as those having polar groups, for example, halogen, hydroxy, ester, alkoxy, carboxy, cyano, amido, imido or silyl groups.

Preferred cycloolefin copolymers include cycloolefin monomers and acyclic olefin monomers, i.e. the above-described cycloolefin monomers can be copolymerized with suitable acyclic olefin comonomers. A preferred comonomer is selected from the group consisting of ethylene, propylene, butylene and combinations thereof. A particularly preferred comonomer is ethylene. Preferred COCs contains about 10-80 mole percent of the cycloolefin monomer moiety and about 90-20 weight percent of the olefin moiety (such as ethylene, referred to as COCE resin). Cycloolefin copolymers which are suitable for the purposes of the present invention typically have a mean molecular weight M_{W} in the range from more than 200 g/mol to 400,000 g/mol. COCs can be characterized by their glass transition temperature, Tg, which is generally in the range from 20° C. to 200° C., preferably in the range from 30° C. to 130° C. In one preferred embodiment the cyclic olefin polymer is a copolymer such as TOPAS® 8007F-04 which includes approximately 36 mole percent norbornene and the balance ethylene. TOPAS® 8007F-04 has a glass transition temperature of about 78° C. Other preferred embodiments include melt blends of partially crystalline cycloolefin elastomer and amorphous COC materials with low glass transition temperatures.

Especially preferred resins include Topas® COCE resins grades 8007 (Tg of 80° C., 5013, 6013 (Tg of 140° C.), and 9506 (Tg of 68° C.). These resins include ethylene and norbornene. Norbornene is also sometimes referred to as bicyclo[2.2.1]hept-2-ene or 2-norbornene as noted above.

The foregoing cycloolefin copolymer resins are usually amorphous; however, cycloolefin copolymer elastomers which have a partially crystalline morphology may also be employed, either alone or blended with another thermoplastic including an amorphous cycloolefin copolymer. Such compositions are described in United States Patent Application Publication 20110256373 entitled Melt blends of amorphous cycloolefin polymers and partially crystalline cycloolefin elastomers with improved toughness. COC elastomers are elastomeric cyclic olefin copolymers available from TOPAS Advanced Polymers. The elastomer features two glass transition temperatures, one of about 6° C. and another glass transition below −90° C. as well as a crystalline melting point of about 84° C. Unlike completely amorphous TOPAS COCE grades, COC elastomers typically contain between 10 and 30 percent crystallinity by weight. Typical properties appear in Table 1:

TABLE 1
Elastomer Properties

| Property | Value | Unit | Test Standard |
|---|---|---|---|
| Physical Properties | | | |
| Density | 940 | kg/m³ | ISO 1183 |
| Melt volume rate (MVR) - @ | 3 | cm³/10 min | ISO 1133 |
| 2.16 kg/190° C. | | | |
| Melt volume rate (MVR) - @ | 12 | cm³/10 min | ISO 1133 |
| 2.16 kg/260° C. | | | |
| Hardness, Shore A | 89 | — | ISO 868 |
| WVTR - @ 23° C./85 RH | 1.0 | g*100 μm/ | ISO 15106-3 |
| | | m² * day | |
| WVTR - @ 38° C./90 RH | 4.6 | g*100 μm/ | ISO 15106-3 |
| | | m² * day | |
| Mechanical Properties | | | |
| Tensile stress at break (50 | >19 | MPa | ISO 527-T2/1A |
| mm/min) | | | |
| Tensile modulus (1 mm/min) | 44 | MPa | ISO 527-T2/1A |
| Tensile strain at break | >450 | % | ISO 527-T2/1A |
| (50 mm/min) | | | |
| Tear Strength | 47 | kN/m | ISO 34-1 |
| Compression set - @ | 35 | % | ISO 815 |
| 24 h/23° C. | | | |
| Compression set - @ | 32 | % | ISO 815 |
| 72 h/23° C. | | | |
| Compression set - @ | 90 | % | ISO 815 |
| 24 h/60° C. | | | |
| Thermal Properties | | | |
| Tg—Glass transition | 6 | ° C. | DSC |
| temperature (10° C./min) | <−90 | | |
| Tₘ—Melt temperature | 84 | ° C. | DSC |
| Vicat softening temperature, | 64 | ° C. | ISO 306 |
| VST/A50 | | | |

As seen above, the elastomer has multiple glass transitions (Tg); one occurs at less than −90° C. and the other occurs in the range from −10° C. to 15° C.

The cycloolefin copolymers may be blended with another thermoplastic resin, including nylons, styrene, ABS resins or other polyolefins. Some especially preferred resins are noted below.

### Polyethylene (PE)

The inventive polymer formulations include a polyethylene component in addition to the cycloolefin/ethylene copolymer resin. Polyethylene is a semicrystalline thermoplastic whose properties depend to a major extent on the polymerization process (Saechtling, Kunststoff-Taschenbuch [Plastics handbook], 27th edition).

“HDPE” is polyethylene having a density of greater or equal to 0.941 g/cc. HDPE has a low degree of branching and thus stronger intermolecular forces and tensile strength. HDPE can be produced by chromium/silica catalysts, Ziegler-Natta catalysts or metallocene catalysts. The lack of branching is ensured by an appropriate choice of catalyst (e.g. Chromium catalysts or Ziegler-Natta catalysts) and reaction conditions.

“LDPE” is polyethylene having a density range of 0.910 -0.940 g/cc. LDPE is prepared at high pressure with free-radical initiation, giving highly branched PE having internally branched side chains of varying length. Therefore, it has less strong intermolecular forces as the instantaneous-dipole induced-dipole attraction is less. This results in a lower tensile strength and increased ductility.

The term “LLDPE” is a substantially linear polyethylene, with significant numbers of short branches, commonly made by copolymerization of ethylene with short-chain α-olefins (e.g. copolymerization with 1-butene, 1-hexene, or 1-octene yield b-LLDPE, h-LLDPE, and o-LLDPE, respectively) via metal complex catalysts. LLDPE is typically manufactured in the density range of 0.915 -0.925 g/cc. However, as a function of the α-olefin used and its content in the LLDPE, the density of LLDPE can be adjusted between that of HDPE and very low densities of 0.865 g/cc. Polyethylenes with very low densities are also termed VLDPE (very low density) or ULDPE (ultra low density). LLDPE has higher tensile strength than LDPE. Exhibits higher impact and puncture resistance than LDPE. Lower thickness (gauge) films can be blown compared to LDPE, with better environmental stress cracking resistance compared to LDPE. Lower thickness (gauge) may be used compared to LDPE.

“MDPE” is polyethylene having a density range of 0.926 -0.940 g/cc. MDPE can be produced by chromium/silica catalysts, Ziegler-Natta catalysts or metallocene catalysts. MDPE has good shock and drop resistance properties. It also is less notch sensitive than HDPE, stress cracking resistance is better than HDPE.

“Polypropylene” includes thermoplastic resins made by polymerizing propylene with suitable catalysts, generally aluminum alkyl and titanium tetrachloride mixed with solvents. This definition includes all the possible geometric arrangements of the monomer unit, such as: with all methyl groups aligned on the same side of the chain (isotactic), with the methyl groups alternating (syndiotactic), all other forms where the methyl positioning is random (atactic), and mixtures thereof.

The blends of the invention may be prepared by any suitable method, including solution blending, melt compounding by coextrusion or melt blending followed by coextrusion. Extrusion blending techniques have the advantage that the blend may be directly melt spun into filaments for FDM processing. Typical extrusion, melt spinning and compounding conditions for representative compositions are set forth in Table 2.

TABLE 2
Twin Screw Extrusion, Melt Spinning and Compounding Conditions

| | Machine Data ZSK-40MC | | | | | |
|---|---|---|---|---|---|---|
| | Pₘₐₓ [kW]: 106 RPMₘₐₓ 1200 | | | | | |
| Structure | | | | | | |
| Thermoplastic I | 92.00% | 84.50% | | | | 39.75% |
| Thermoplastic II | | | | 92.00% | 84.50% | |
| Thermoplastic III | | | 89.50% | | | 39.75% |
| Cycloolefin | 7.50% | 15.00% | 10.00% | 7.50% | 15.00% | 20.00% |
| Copolymer | | | | | | |
| Hostanox 010 | 0.25% | 0.25% | 0.25% | 0.25% | 0.25% | 0.25% |
| Licowax C | 0.25% | 0.25% | 0.25% | 0.25% | 0.25% | 0.25% |
| Screw # | | | | | | |
| Screw Speed | 275 | 290 | 325 | 325 | 325 | 300 |
| [1/min] | | | | | | |
| Torque [%] | 93-95 | 92-93 | 90-91 | 86-90 | 88-90 | 91-93 |
| Power [kW] | 24.2 | | 26.0 | | | 24.5 |
| Rate [lb/hr] | 402 | 402 | 402 | 402 | 400 | 400 |
| S-mech (SEI) | 0.136 | | 0.142 | | | 0.135 |
| [kWh/kg] | | | | | | |
| Tₘₑₗₜ (° C.) Die | 251 | 252 | 280 | 280 | 280 | 271 |
| PDie (psig) Die | 340 | 340 | 310 | 300 | 280 | 300 |

Using a blended material made as noted generally above or a cycloolefin copolymer elastomer alone, three-dimensional articles are made by an FDM apparatus as shown schematically in the FIGURE. Feed assembly 12 dispenses polymer 14 in filament form onto build platform 18, in a layer-by-layer process, to form three-dimensional object 16. Once three-dimensional object 16 is completed, it may be removed from build platform 18 and a new project may begin.

While the invention has been described in detail, modifications within the spirit and scope of the invention will be readily apparent to those of skill in the art. In view of the foregoing discussion, relevant knowledge in the art and references discussed above in connection with the Background of the Invention and the detailed description, the disclosures of which are all incorporated herein by reference, further description is deemed unnecessary. In addition, it should be understood that aspects of the invention and portions of various embodiments may be combined or interchanged either in whole or in part. Furthermore, those of ordinary skill in the art will appreciate that the foregoing description is by way of example only, and is not intended to limit the invention.

What is claimed is:

1. A method of making a three-dimensional article comprising:
(a) providing a polymer blend which includes a cycloolefin copolymer and another thermoplastic resin; and
(b) printing the polymer blend into the three-dimensional article.

2. The method according to claim 1, wherein the step of printing the polymer blend into a three-dimensional article is carried out by a technique selected from FDM, SHS or SLS.

3. The method according to claim 1, wherein the cycloolefin copolymer is a norbornene/ethylene copolymer.

4. The method according to claim 1, wherein the cycloolefin copolymer is an amorphous norbornene/ethylene copolymer.

5. The method according to claim 1, wherein the thermoplastic resin is selected from ABS and partially crystalline olefin polymers.

6. The method according to claim 1, wherein the thermoplastic resin is a partially crystalline linear alkylene polymer.

7. The method according to claim 1, wherein the thermoplastic resin is selected from polypropylene, polyethylene and polyoctene.

8. The method according to claim 1, wherein the weight ratio of cycloolefin copolymer:thermoplastic resin in the blend is from 2:98 to 98:2.

9. The method according to claim 1, wherein the weight ratio of cycloolefin copolymer:thermoplastic resin in the blend is from 2:98 to 20:80.

10. The method according to claim 1, wherein the polymer blend exhibits superior performance as compared with the thermoplastic resin in the blend in connection with at least one of the following properties: dimensional stability;
optical transmission; gloss; or barrier properties.

11. A three-dimensional article formed by the process of claim 1.

12. The three-dimensional article according to claim 11, wherein the article exhibits superior performance in connection with at least one of the following properties: dimensional stability; optical transmission; gloss; or barrier properties as compared with a like article made by a like process made from the thermoplastic resin in the blend only.

13. A method of making a three-dimensional article comprising:
(a) providing a polymer composition which includes a cycloolefin copolymer elastomer and optionally another thermoplastic resin; and
(b) printing the polymer composition into the three-dimensional article.

14. The method according to claim 13, wherein the step of printing the polymer composition into a three-dimensional article is carried out by a technique selected from FDM, SHS or SLS.

15. The method according to claim 13, wherein the polymer composition includes a thermoplastic resin selected from ABS and partially crystalline olefin polymers.

16. The method according to claim 15, wherein the thermoplastic resin is a partially crystalline linear alkylene polymer.

17. The method according to claim 15, wherein the thermoplastic resin is selected from polypropylene, polyethylene, polyoctene and amorphous cyclolefin copolymers.

18. The method according to claim 15, wherein the weight ratio of cycloolefin copolymer elastomer:thermoplastic resin in the blend is from 2:98 to 98:2.

19. The method according to claim 15, wherein the weight ratio of cycloolefin copolymer elastomer:thermoplastic resin in the blend is from 2:98 to 20:80.
